(19) United States
(12) Patent Application Publication
(10) Pub. No.: US 2026/0073552 A1
(43) Pub. Date: Mar. 12, 2026

(54) ADAPTIVE POSEGRAPH-BASED LOCALIZATION

(71) Applicant: Snap Inc., Santa Monica, CA (US)

(72) Inventors: Markus Diem, Vienna (AT); Georg Halmetschlager-Funek, Vienna (AT); Nikolaj Kuntner, Vienna (AT); Simon Schreiberhuber, Vienna (AT)

(73) Assignee: Snap Inc., Santa Monica, CA (US)

(21) Appl. No.: 18/829,068

(22) Filed: Sep. 9, 2024

(51) Int. Cl. G06T 7/70; G06T 7/579; G06V 10/44; G06V 40/16

(52) U.S. Cl. CPC G06T 7/70; G06T 7/579; G06V 10/44; G06V 40/161

(57) ABSTRACT

A system and method for generating and updating a posegraph for multi-user augmented reality experiences. The system receives initial pose data from multiple client devices and generates a posegraph based on this data. When client devices come within proximity of each other, the system detects this and receives relative pose observations from the devices. The system then updates the posegraph based on these observations, assigning confidence values to improve accuracy. This approach enables efficient synchronization of spatial information across devices, allowing for seamless shared AR experiences in large-scale environments without the need for complete map sharing or pre-mapped areas.

### BACKGROUND

Augmented reality (AR) applications increasingly involve multiple users interacting in shared large-scale environments. A key challenge in enabling seamless multi-user AR experiences is maintaining a consistent shared coordinate frame across all participating devices.

Conventional approaches to this problem have significant limitations. Visual-inertial odometry (VIO) allows individual devices to track their own position, but leads to drift over time and lacks synchronization between devices. Simultaneous localization and mapping (SLAM) can provide initial alignment and some drift correction, but synchronizing entire SLAM systems between devices requires excessive bandwidth.

Existing solutions often rely on sharing complete maps or map chunks between devices, which is bandwidth-intensive and limits scalability. Other approaches use markers, tags, or external tracking systems, constraining the environments where the technology can be deployed. Some systems only work in small, pre-mapped areas, restricting their utility for large-scale or ad-hoc AR experiences.

There is a need for a more efficient and scalable method to establish and maintain a shared coordinate system across multiple AR devices. Such a system should be able to fuse data from various sensors, compensate for drift, and operate in large-scale environments without requiring extensive pre-mapping or specialized infrastructure. Additionally, the solution should minimize bandwidth usage to enable real-time synchronization across a network of devices.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings in which:

FIG. 1 is a diagrammatic representation of a networked environment in which the present disclosure may be deployed, in accordance with some examples.

FIG. 2 is a diagrammatic representation of a messaging system, in accordance with some examples, that has both client-side and server-side functionality.

FIG. 3 is a flowchart depicting a method for generating and updating a posegraph, in accordance with one example.

FIG. 4 is a flowchart depicting a method for generating and updating a posegraph, in accordance with one example.

FIG. 5 is a flowchart depicting a method for generating and updating a posegraph, in accordance with one example.

FIG. 6 is a diagram depicting a method for generating and updating a posegraph, in accordance with one example.

FIG. 7 is a diagrammatic representation of a machine in the form of a computer system within which a set of instructions may be executed for causing the machine to perform any one or more of the methodologies discussed herein, in accordance with some examples.

FIG. 8 is a block diagram showing a software architecture within which examples may be implemented.

FIG. 9 is a diagrammatic representation of a processing environment, in accordance with some examples.

### DETAILED DESCRIPTION

The present disclosure relates to a Posegraph Optimization System (POS) to enable multi-user augmented reality (AR) experiences. In some examples, the POS addresses the challenge of maintaining a consistent shared coordinate frame across multiple AR devices in large-scale environments.

As discussed above, in AR applications involving multiple users, it is crucial to establish and maintain a common understanding of the spatial relationships between devices and their surroundings. Traditional approaches, such as sharing complete maps or relying on pre-mapped environments, often fall short in terms of scalability, bandwidth efficiency, and adaptability to dynamic, large-scale scenarios.

The POS introduces a novel approach that leverages posegraphs-undirected graphs representing device poses connected by relative pose observations-to efficiently synchronize spatial information across multiple devices. This system enables real-time, low-bandwidth sharing of localization data, allowing for seamless multi-user AR experiences in diverse environments.

According to certain examples, the POS may comprise components that include: client devices equipped with various sensors; a central processing system for posegraph management and optimization; and a communication network for data exchange. These components work in concert to collect, process, and distribute spatial information across the network of AR devices.

According to certain examples, the system may begin by receiving initial pose data from participating client devices. This initial data may include visual-inertial odometry (VIO) information, Global Navigation Satellite System (GNSS) coordinates, WiFi signal strength data, image data, and inertial measurement unit (IMU) readings. Using these inputs, the POS generates an initial posegraph representing the relative positions and orientations of the devices in the shared space.

As users explore their environment, the POS continuously updates and refines the posegraph. In some examples, the process may include the detection of proximity between devices. For example, when location data received from two or more devices come within a certain threshold distance of each other, the system triggers the collection of relative pose observations.

In some examples, these relative pose observations can be derived from various sources, including visual feature matching between image features of images captured by device cameras, direct device-to-device detection, ultrawideband (UWB) measurements, Bluetooth signal strength data, and even shared observations of common environmental features like hand gestures or mapped landmarks.

In some examples, to ensure the accuracy and reliability of the posegraph, the POS assigns confidence values to different types of observations. For example, high-precision UWB measurements might be given more weight than less accurate WiFi-based distance estimates. These confidence values are used in the posegraph optimization process to balance the influence of various data sources and minimize overall error.

In some examples, the POS applies a continuous optimization process, which uses techniques such as Bundle Adjustment to refine the posegraph based on new observations and minimize accumulated errors. This optimization occurs in real-time as new data is received, allowing the system to maintain an up-to-date and consistent representation of the shared AR space.

Accordingly, by sharing only essential edge information rather than complete maps or raw sensor data, the system minimizes bandwidth requirements while still enabling accurate multi-device localization. This approach allows the POS to support large numbers of users in expansive, dynamic environments without compromising on real-time performance or spatial consistency.

### Networked Computing Environment

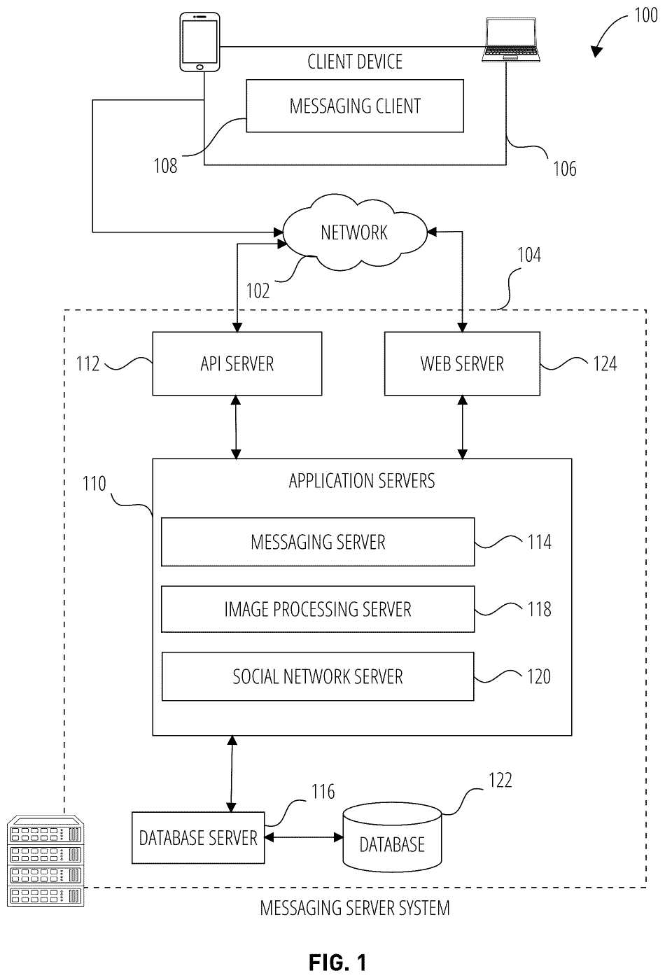

FIG. 1 is a block diagram showing an example messaging system 100 for exchanging data (e.g., messages and associated content) over a network. The messaging system 100 includes multiple instances of a client device 106, each of which hosts a number of applications, including a messaging client 108. Each messaging client 108 is communicatively coupled to other instances of the messaging client 108 and a messaging server system 104 via a network 102 (e.g., the internet).

A messaging client 108 is able to communicate and exchange data with another messaging client 108 and with the messaging server system 104 via the network 102. The data exchanged between messaging client 108, and between a messaging client 108 and the messaging server system 104, includes functions (e.g., commands to invoke functions) as well as payload data (e.g., text, audio, video or other multimedia data).

The messaging server system 104 provides server-side functionality via the network 102 to a particular messaging client 108. While certain functions of the messaging system 100 are described herein as being performed by either a messaging client 108 or by the messaging server system 104, the location of certain functionality either within the messaging client 108 or the messaging server system 104 may be a design choice. For example, it may be technically preferable to initially deploy certain technology and functionality within the messaging server system 104 but to later migrate this technology and functionality to the messaging client 108 where a client device 106 has sufficient processing capacity.

The messaging server system 104 supports various services and operations that are provided to the messaging client 108. Such operations include transmitting data to, receiving data from, and processing data generated by the messaging client 108. This data may include message content, client device information, geolocation information, media augmentation and overlays, message content persistence conditions, social network information, and live event information, as examples. Data exchanges within the messaging system 100 are invoked and controlled through functions available via user interfaces (UIs) of the messaging client 108.

Turning now specifically to the messaging server system 104, an Application Program Interface (API) server 112 is coupled to, and provides a programmatic interface to, application servers 110. The application servers 110 are communicatively coupled to a database server 116, which facilitates access to a database 122 that stores data associated with messages processed by the application servers 110. Similarly, a web server 124 is coupled to the application servers 110, and provides web-based interfaces to the application servers 110. To this end, the web server 124 processes incoming network requests over the Hypertext Transfer Protocol (HTTP) and several other related protocols. In certain embodiments, the database 122 may include a decentralized database.

The Application Program Interface (API) server 112 receives and transmits message data (e.g., commands and message payloads) between the client device 106 and the application servers 110. Specifically, the Application Program Interface (API) server 112 provides a set of interfaces (e.g., routines and protocols) that can be called or queried by the messaging client 108 in order to invoke functionality of the application servers 110. The Application Program Interface (API) server 112 exposes various functions supported by the application servers 110, including account registration, login functionality, the sending of messages, via the application servers 110, from a particular messaging client 108 to another messaging client 108, the sending of media files (e.g., images or video) from a messaging client 108 to a messaging server 114, and for possible access by another messaging client 108, the settings of a collection of media data (e.g., story), the retrieval of a list of friends of a user of a client device 106, the retrieval of such collections, the retrieval of messages and content, the addition and deletion of entities (e.g., friends) to an entity graph (e.g., a social graph), the location of friends within a social graph, and opening an application event (e.g., relating to the messaging client 108).

The application servers 110 host a number of server applications and subsystems, including for example a messaging server 114, an image processing server 118, and a social network server 120. The messaging server 114 implements a number of message processing technologies and functions, particularly related to the aggregation and other processing of content (e.g., textual and multimedia content) included in messages received from multiple instances of the messaging client 108. As will be described in further detail, the text and media content from multiple sources may be aggregated into collections of content (e.g., called stories or galleries). These collections are then made available to the messaging client 108. Other processor and memory intensive processing of data may also be performed server-side by the messaging server 114, in view of the hardware requirements for such processing.

The application servers 110 also include an image processing server 118 that is dedicated to performing various image processing operations, typically with respect to images or video within the payload of a message sent from or received at the messaging server 114.

The social network server 120 supports various social networking functions and services and makes these functions and services available to the messaging server 114. Examples of functions and services supported by the social network server 120 include the identification of other users of the messaging system 100 with which a particular user has relationships or is “following,” and also the identification of other entities and interests of a particular user.

### System Architecture

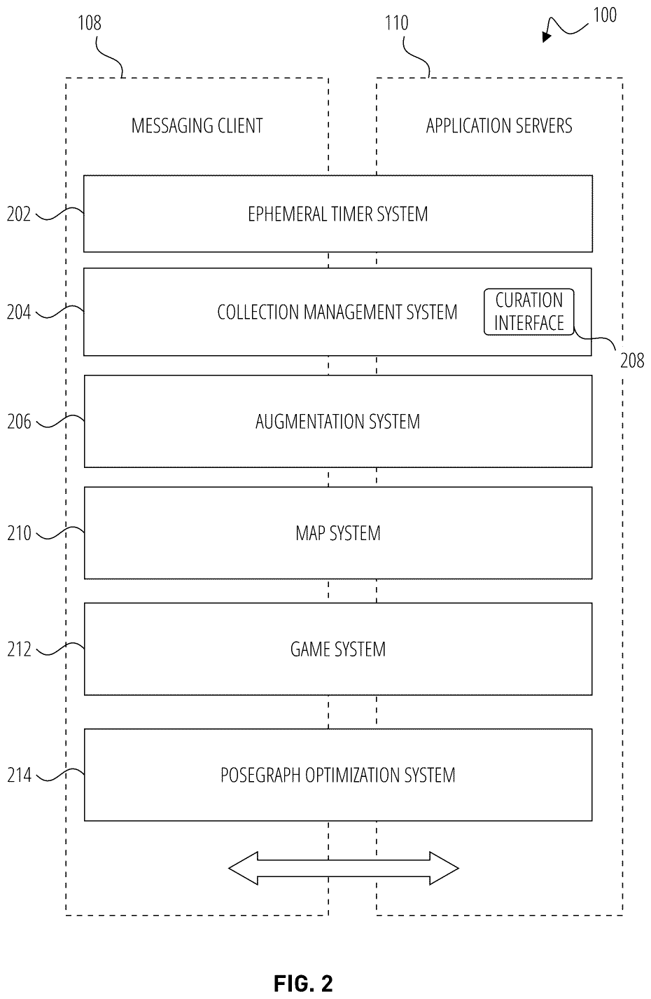

FIG. 2 is a block diagram illustrating further details regarding the messaging system 100, according to some examples. Specifically, the messaging system 100 is shown to comprise the messaging client 108 and the application servers 110. The messaging system 100 embodies a number of subsystems, which are supported on the client-side by the messaging client 108 and on the sever-side by the application servers 110. These subsystems include, for example, an ephemeral timer system 202, a collection management system 204, an augmentation system 206, a map system 210, a game system 212, and a posegraph optimization system 214.

The ephemeral timer system 202 is responsible for enforcing the temporary or time-limited access to content by the messaging client 108 and the messaging server 114. The ephemeral timer system 202 incorporates a number of timers that, based on duration and display parameters associated with a message, or collection of messages (e.g., a story), selectively enable access (e.g., for presentation and display) to messages and associated content via the messaging client 108. Further details regarding the operation of the ephemeral timer system 202 are provided below.

The collection management system 204 is responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client 108.

The collection management system 204 furthermore includes a curation interface 208 that allows a collection manager to manage and curate a particular collection of content. For example, the curation interface 208 enables an event organizer to curate a collection of content relating to a specific event (e.g., delete inappropriate content or redundant messages). Additionally, the collection management system 204 employs machine vision (or image recognition technology) and content rules to automatically curate a content collection. In certain examples, compensation may be paid to a user for the inclusion of user-generated content into a collection. In such cases, the collection management system 204 operates to automatically make payments to such users for the use of their content.

The augmentation system 206 provides various functions that enable a user to augment (e.g., annotate or otherwise modify or edit) media content associated with a message. For example, the augmentation system 206 provides functions related to the generation and publishing of media overlays for messages processed by the messaging system 100. The augmentation system 206 operatively supplies a media overlay or augmentation (e.g., an image filter) to the messaging client 108 based on a geolocation of the client device 106. In another example, the augmentation system 206 operatively supplies a media overlay to the messaging client 108 based on other information, such as social network information of the user of the client device 106. A media overlay may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo) at the client device 106. For example, the media overlay may include text or image that can be overlaid on top of a photograph taken by the client device 106. In another example, the media overlay includes an identification of a location overlay (e.g., Venice beach), a name of a live event, or a name of a merchant overlay (e.g., Beach Coffee House). In another example, the augmentation system 206 uses the geolocation of the client device 106 to identify a media overlay that includes the name of a merchant at the geolocation of the client device 106. The media overlay may include other indicia associated with the merchant. The media overlays may be stored in the database 122 and accessed through the database server 116.

In some examples, the augmentation system 206 provides a user-based publication platform that enables users to select a geolocation on a map and upload content associated with the selected geolocation. The user may also specify circumstances under which a particular media overlay should be offered to other users. The augmentation system 206 generates a media overlay that includes the uploaded content and associates the uploaded content with the selected geolocation.

In other examples, the augmentation system 206 provides a merchant-based publication platform that enables merchants to select a particular media overlay associated with a geolocation via a bidding process. For example, the augmentation system 206 associates the media overlay of the highest bidding merchant with a corresponding geolocation for a predefined amount of time.

The map system 210 provides various geographic location functions, and supports the presentation of map-based media content and messages by the messaging client 108. For example, the map system 210 enables the display of user icons or avatars on a map to indicate a current or past location of “friends” of a user, as well as media content (e.g., collections of messages including photographs and videos) generated by such friends, within the context of a map. For example, a message posted by a user to the messaging system 100 from a specific geographic location may be displayed within the context of a map at that particular location to “friends” of a specific user on a map interface of the messaging client 108. A user can furthermore share his or her location and status information (e.g., using an appropriate status avatar) with other users of the messaging system 100 via the messaging client 108, with this location and status information being similarly displayed within the context of a map interface of the messaging client 108 to selected users.

The game system 212 provides various gaming functions within the context of the messaging client 108. The messaging client 108 provides a game interface providing a list of available games that can be launched by a user within the context of the messaging client 108, and played with other users of the messaging system 100. The messaging system 100 further enables a particular user to invite other users to participate in the play of a specific game, by issuing invitations to such other users from the messaging client 108. The messaging client 108 also supports both the voice and text messaging (e.g., chats) within the context of gameplay, provides a leaderboard for the games, and also supports the provision of in-game rewards (e.g., coins and items).

According to certain embodiments, the posegraph optimization system 214 provides functions that may include: receiving and processing initial pose data from multiple client devices 106, including visual-inertial odometry (VIO) data, GNSS coordinates, WiFi signal strength data, image data, and IMU readings. As client devices 106 move and explore their environment, the posegraph optimization system 214 may continuously updates and refine the posegraph by processing new data received from the devices, including relative pose observations triggered when devices come within proximity of each other. The system may integrate various types of data from client devices 106, such as visual feature matching, device-to-device detection, UWB measurements, and Bluetooth signal strength. In some examples, the posegraph optimization system 214 may assign confidence values to different types of observations and uses optimization techniques like Bundle Adjustment to refine the posegraph and minimize accumulated errors.

After processing and optimizing the posegraph, the system may send updated information back to the client devices 106 via the network 102, ensuring all devices maintain a synchronized view of the shared AR space.

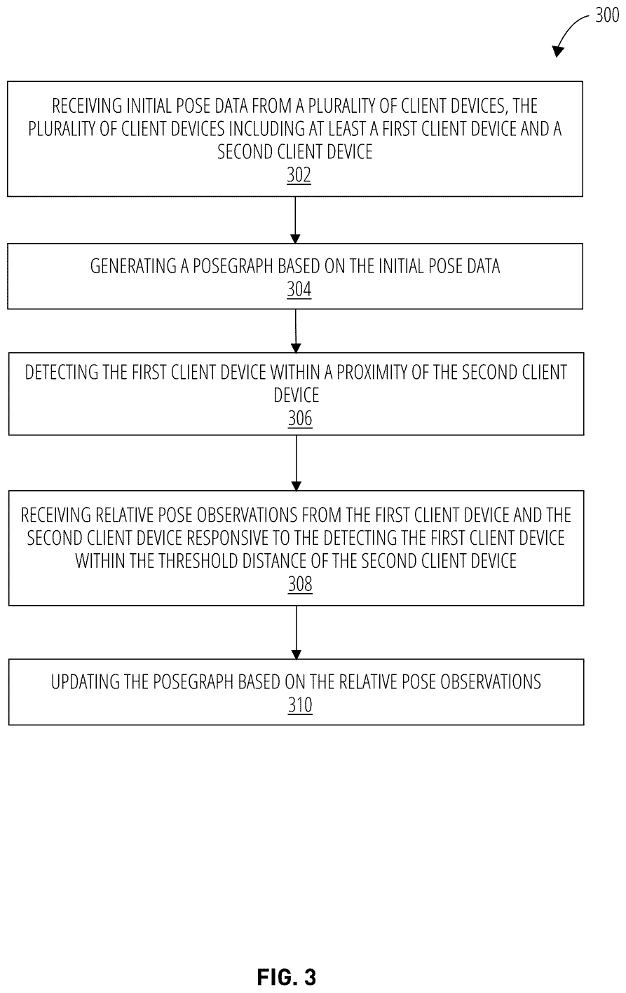

FIG. 3 is a flowchart illustrating operations of a posegraph optimization system 214 in performing a method 300 for generating and updating a posegraph, in accordance with one example. Operations of the method 300 may be performed by one or more subsystems of the messaging system 100 described above with respect to FIG. 2, such as the posegraph optimization system 214. As shown in FIG. 3, the method 300 includes one or more operations 302, 304, 306, 308, and 310.

At operation 302 the system receives initial pose data. For example, the method 300 may begin with the posegraph optimization system 214 receiving initial pose data from a plurality of client devices 106, including at least a first client device and a second client device. This initial pose data may comprise various types of information, including but not limited to: Visual-inertial odometry (VIO) data; Global Navigation Satellite System (GNSS) coordinates; WiFi signal strength data; image data; and Inertial Measurement Unit (IMU) readings.

Each client device 106 collects this data using its onboard sensors and transmits it to the posegraph optimization system 214 via the network 102. The system may receive this data in various formats and protocols, depending on the specific implementation of the client devices and the network infrastructure.

At operation 304, the posegraph optimization system 214 generates a posegraph based on the collected data. A posegraph is an undirected graph where nodes represent device poses (position and orientation) at specific points in time, and edges represent relative pose observations between these nodes.

The system processes the received data to create an initial set of nodes representing the starting positions of each client device. It then establishes edges between these nodes based on any available relative pose information, such as devices that may have already detected each other or shared landmarks in their initial observations.

In some examples, in generating the posegraph, the system may employ various algorithms and techniques known to those skilled in the art, such as: graph optimization techniques to minimize errors in the initial pose estimates; outlier detection and rejection to handle potentially erroneous data; coordinate system alignment to ensure all devices are represented in a common frame of reference.

At operation 306, as the client devices 106 move through the environment, the posegraph optimization system 214 continuously monitors their positions to detect when devices come within proximity of each other. This proximity detection can be implemented using various methods, including: threshold distance calculation based on estimated device positions; signal strength measurements (e.g., Bluetooth, WiFi, or Ultra-wideband); visual detection of other devices or shared environmental features within images collected by the devices; and acoustic ranging techniques.

The system may employ a combination of these methods to improve the robustness and accuracy of proximity detection. Additionally, the proximity threshold may be dynamically adjusted based on factors such as the density of devices in the area, the type of environment, or the specific requirements of the AR application.

At operation 308, responsive to detecting that the first client device is within proximity of the second client device, the system triggers the collection of relative pose observations from both devices. In some examples, proximity may refer to a condition where data relevant to deriving relative poses between two or more client devices becomes available, allowing the system to establish or refine a shared coordinate frame. For example, this condition may not be limited to physical closeness or simultaneous presence of devices in the same location. Instead, proximity may encompass a range of scenarios that enable the system to compute or refine relative poses between devices.

In some examples, proximity may include situations where devices are physically close enough to directly observe or detect each other, such as through visual feature matching or direct device-to-device detection. In some examples, proximity may also cover instances where devices share observations of common environmental features, either simultaneously or at different times. This could involve detecting shared landmarks, hand gestures, or other distinctive elements in the environment. Accordingly, the system can align individual coordinate frames through shared map data or landmarks, even when the devices are not physically present in the same place at the same time.

More broadly, proximity may encompass any situation where sufficient data can be collected to compute or refine relative poses between devices, regardless of their temporal or spatial separation. This could include the use of various data sources such as visual features, inertial measurements, radio-based signals (e.g., UWB, Bluetooth, WiFi), or any other relevant sensor data that contributes to pose estimation.

The relative pose observations provide more accurate information about the relative positions and orientations of the devices compared to their individual pose estimates. Relative pose observations can be obtained through various means, including: visual feature matching between device cameras; direct device-to-device detection and ranging; shared observations of common environmental features or landmarks; sensor fusion of multiple data sources (e.g., visual, inertial, and radio-based measurements).

The system may request these observations from the client devices or the devices may automatically send the data when they detect proximity to another device. The relative pose observations typically include: estimated relative position vector; relative orientation (e.g., as a rotation matrix or quaternion); uncertainty estimates or covariance information; timestamps to synchronize observations from multiple devices.

At operation 310 the system updates the posegraph based on the received relative pose observations. The posegraph optimization system 214 incorporates the new relative pose observations as edges in the posegraph, connecting the nodes representing the current poses of the first and second client devices. In some examples, this process may include: adding new nodes to the graph to represent the updated poses of the devices; creating or updating edges between nodes based on the relative pose observations; assigning confidence values or weights to the new edges based on the estimated accuracy of the observations; and performing optimization of the posegraph to minimize overall error and maintain consistency.

This optimization process may employ various techniques depending on factors such as the size of the posegraph, available computational resources, real-time requirements of the application, and the nature of the new observations being incorporated. These techniques can include global optimization methods that consider the entire posegraph structure simultaneously, incremental optimization approaches that efficiently update the graph without recomputing the entire structure, local optimization strategies focusing on specific subgraphs or regions of interest, and hierarchical optimization methods that operate at multiple scales or levels of detail. The chosen optimization approach aims to effectively balance accuracy, computational efficiency, and the specific needs of the multi-user augmented reality experience. According to certain examples, the system may employ various optimization techniques, including but not limited to: Bundle Adjustment; graph-based SLAM (Simultaneous Localization and Mapping); and Kalman filtering or its variants (e.g., Extended Kalman Filter, Unscented Kalman Filter).

After updating the posegraph, the system may distribute the refined pose estimates back to the client devices 106 via the network 102, ensuring that all devices maintain a synchronized view of the shared AR space.

In some examples, the posegraph optimization system 214 may implement additional features such as: adaptive sampling rates for pose updates based on device movement and proximity to other devices; integration with the map system 210 to incorporate persistent environmental features and improve long-term localization accuracy; handling of dynamic objects and temporary occlusions in the environment; support for heterogeneous devices with varying sensor capabilities and accuracy levels; and privacy-preserving mechanisms to protect user data while still enabling accurate localization and synchronization.

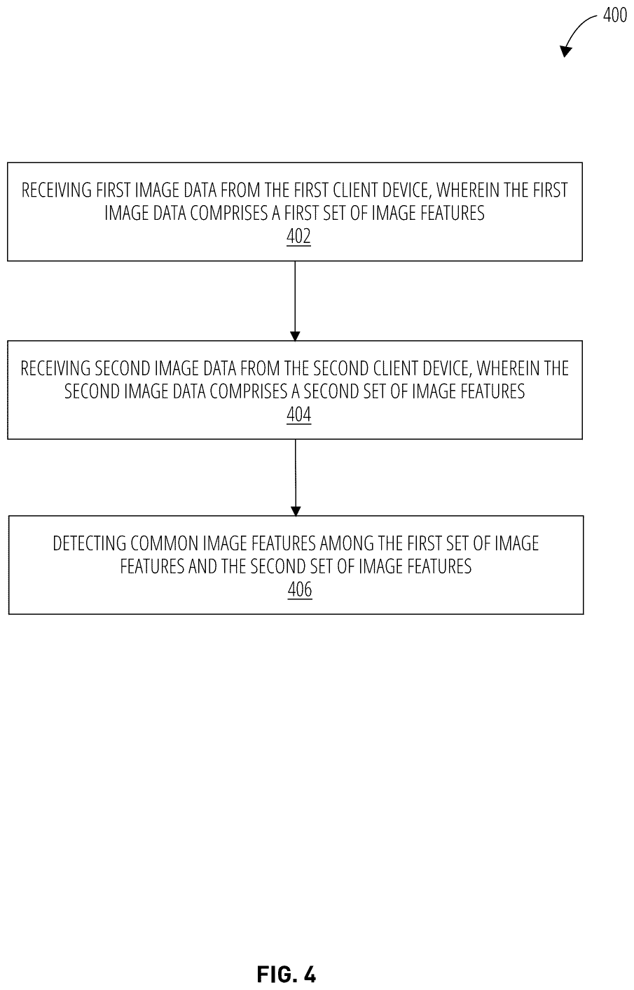

FIG. 4 is a flowchart illustrating operations of a posegraph optimization system 214 in performing a method 400 for generating and updating a posegraph, in accordance with one example. Operations of the method 400 may be performed by one or more subsystems of the messaging system 100 described above with respect to FIG. 2, such as the posegraph optimization system 214. As shown in FIG. 4, the method 400 includes one or more operations 402, 404, and 406. In some embodiments, operations of the method 400 may be performed as a precursor or subroutine of one or more operations of the method 300, such as operation 306.

At operation 402, the posegraph optimization system 214 receives first image data from the first client device. This image data comprises a first set of image features, which are distinctive visual elements extracted from the device's camera feed. These features may include corners, edges, blobs, or more complex descriptors such as SIFT (Scale-Invariant Feature Transform) or ORB (Oriented FAST and Rotated BRIEF) features. The system may receive this data in various formats, such as raw pixel data, compressed images, or pre-processed feature descriptors, depending on the implementation and available bandwidth.

At operation 404, the system performs a similar operation for the second client device, receiving second image data comprising a second set of image features. This parallel process allows the system to gather visual information from multiple devices simultaneously, enabling it to compare and analyze the spatial relationships between them. The timing and frequency of these image data transmissions may be adjusted based on factors such as device movement, network conditions, and the specific requirements of the AR application.

At operation 406, the posegraph optimization system 214 detects common image features among the first set of image features and the second set of image features. In some examples, the detection of common features may include: feature matching, wherein the system compares the feature descriptors from both sets of image data to find correspondences; geometric verification, wherein, the system may perform additional checks to ensure the spatial arrangement of the matched features is consistent; homography or fundamental matrix estimation, wherein the system may compute a transformation matrix that relates the matched features between the two images; confidence scoring, wherein the system may assign a confidence score to the feature matching results based on factors such as the number of matched features, their spatial distribution, attributes of the client devices, and the consistency of the geometric relationships.

According to certain examples, the detection of common image features may serve multiple purposes in the context of the posegraph optimization system, including: proximity detection, wherein a high number of matched features indicates that the devices are likely observing the same scene, suggesting they are in close proximity; relative pose estimation, wherein the spatial relationships between matched features can be used to compute the relative position and orientation of the devices, providing valuable input for the posegraph update process; loop closure detection, wherein in the broader context of SLAM (Simultaneous Localization and Mapping), detecting common features can help identify when a device has returned to a previously visited location, enabling more accurate global optimization of the posegraph; and map expansion and refinement, wherein shared observations of environmental features contribute to building and improving a collective understanding of the space, which can be integrated into the map system 210 for long-term localization improvements.

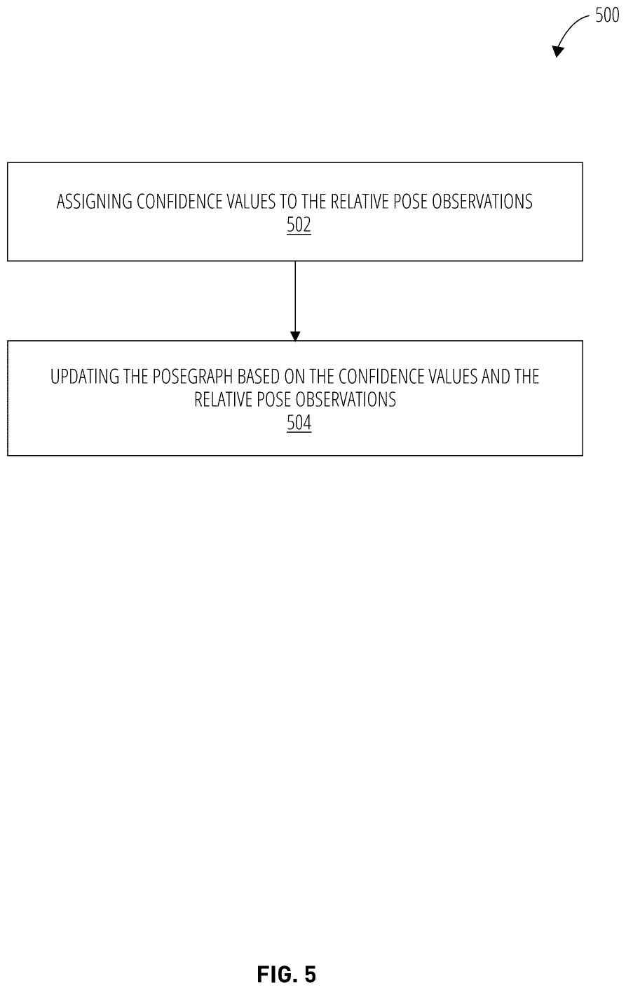

FIG. 5 is a flowchart illustrating operations of a posegraph optimization system 214 in performing a method 500 for generating and updating a posegraph, in accordance with one example. Operations of the method 500 may be performed by one or more subsystems of the messaging system 100 described above with respect to FIG. 2, such as the posegraph optimization system 214. As shown in FIG. 5, the method 500 includes one or more operations 502 and 504. In some embodiments, operations of the method 500 may be performed as a precursor or subroutine of one or more operations of the method 300, such as operation 310.

According to certain examples, at operation 502, the posegraph optimization system 214 assigns confidence values to the relative pose observations received from the client devices. These confidence values represent the system's assessment of the reliability and accuracy of each observation, allowing for more nuanced integration of new data into the posegraph. The assignment of confidence values may be based on various factors, including: the type of sensor or method used to obtain the observation (e.g., visual, inertial, or radio-based measurements); the estimated accuracy of the sensors involved; the environmental conditions at the time of measurement (e.g., lighting, occlusions, or potential interference); the relative geometry between the observing devices; historical performance of similar observations; and attributes of the devices themselves, including a device type.

For example, ultra-wideband (UWB) measurements might be assigned higher confidence values compared to WiFi-based distance estimates due to their generally higher accuracy. Similarly, visual observations made under good lighting conditions might receive higher confidence than those made in low-light environments.

The system may employ various algorithms and techniques to determine these confidence values, such as: statistical analysis of sensor error characteristics; machine learning models trained on historical data to predict observation reliability; heuristic rules based on expert knowledge of sensor performance in different scenarios; and real-time assessment of environmental factors affecting sensor accuracy.

At operation 504, the posegraph optimization system 214 updates the posegraph based on the confidence values and the relative pose observations. This step involves integrating the new observations into the existing graph structure while taking into account their assigned confidence values. According to certain examples, the update process may include one or more of: adding new nodes to the posegraph to represent the updated poses of the devices involved in the observations; creating or updating edges between nodes based on the relative pose observations; adjusting the values of existing poses (value-correction) when new information suggests a refinement is necessary; weighting the influence of each observation on the graph optimization process according to its assigned confidence value; and performing an optimization of the posegraph to minimize overall error and maintain consistency. The specific actions taken during an update may vary depending on the nature of the new observations, the current state of the posegraph, and the system's optimization strategy. In some cases, the update might only involve adding new poses, while in others, it may include correcting values of existing poses to maintain overall consistency and accuracy of the posegraph.

The system may employ various optimization techniques known in the art to perform this update, such as: weighted least squares optimization, where the weights are derived from the confidence values; factor graph optimization, incorporating the confidence values as factors in the graph; robust estimation techniques (e.g., M-estimators) to handle potential outliers or observations with low confidence; and incremental optimization methods to efficiently update the graph without re-computing the entire structure.

Accordingly, by incorporating confidence values into the posegraph update process, the system can more effectively handle the inherent uncertainties and variabilities in sensor measurements and environmental conditions. This approach allows for a more robust and accurate representation of the shared AR space, as it can prioritize more reliable observations when resolving conflicts or inconsistencies in the graph while also adapting to changing environmental conditions that may affect sensor performance.

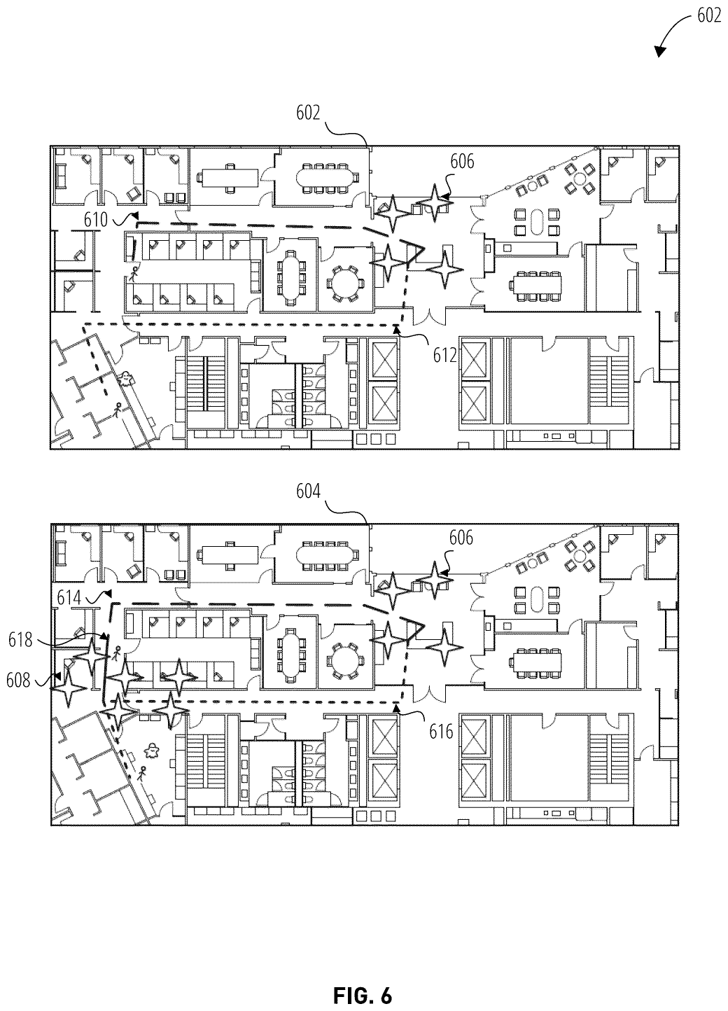

FIG. 6 illustrates a diagram 600 depicting a method for generating and updating a posegraph, in accordance with one example. The diagram consists of two map images, 602 and 604, which visually represent the evolution of the posegraph as new localization data is incorporated.

Map image 602 displays the initial state of the posegraph, including posegraphs 610 and 612, which correspond to a first client device and a second client device, respectively. This image also includes a display of localization features/initial data 606, which may be captured by one or more client devices 106. For example, these localization features could include visual landmarks, WiFi signal strength data, GNSS coordinates, or other sensor readings that contribute to the initial pose estimation of the devices.

The posegraphs 610 and 612 in map image 602 represent the initial relative positions and orientations of the two client devices. Each node in these posegraphs corresponds to a device pose at a specific point in time, while the edges between nodes represent the relative pose observations between these poses. The initial posegraph is generated based on the initial pose data received from the client devices, as described in operation 304 of the method 300.

Map image 604 displays the updated state of the posegraph, including updated posegraphs 614 and 616, which correspond to the first and second client devices. This image also includes a display of co-observed scene features 608, which are visual landmarks detected by both devices. These co-observed scene features are then used to compute a relative pose observation, represented by a new edge 618 in the posegraph. This relative pose observation is utilized by the system to update the initial posegraphs 610 and 612, resulting in the updated posegraphs 614 and 616. The display of scene features is not meant to limit the source of relative pose observations to this source. Other methods described in this filing are valid sources for relative pose observations. According to certain examples, the process of updating the posegraph may involve several steps, as outlined in the methods 300, 400, and 500.

In some examples, the system detects when the first client device comes within proximity of the second client device, as described in operation 306 of method 300. This could be achieved through various means, including the image feature matching process detailed in method 400.

Once proximity is detected, the system receives relative pose observations from both client devices, as described in operation 308 of method 300, and depicted as the relative pose observations 608 in the map image 604. These observations provide more accurate information about the relative positions and orientations of the devices.

In some examples, the system assigns confidence values to the relative pose observations 608, as detailed in operation 502 of method 500. These confidence values represent the system's assessment of the reliability and accuracy of each observation.

Finally, the system updates the posegraph based on the new observations and their associated confidence values, as described in operations 310 of method 300 and 504 of method 500. This update process involves adding new nodes to represent the updated poses of the devices, creating or updating edges based on the relative pose observations, and performing a global optimization to minimize overall error and maintain consistency.

The updated posegraphs 614 and 616 in map image 604 reflect these changes. New nodes and edges may be visible, representing the additional pose information gathered during the update process. The relative positions of the posegraphs may also have shifted, indicating corrections made based on the new observations.

### Machine Architecture

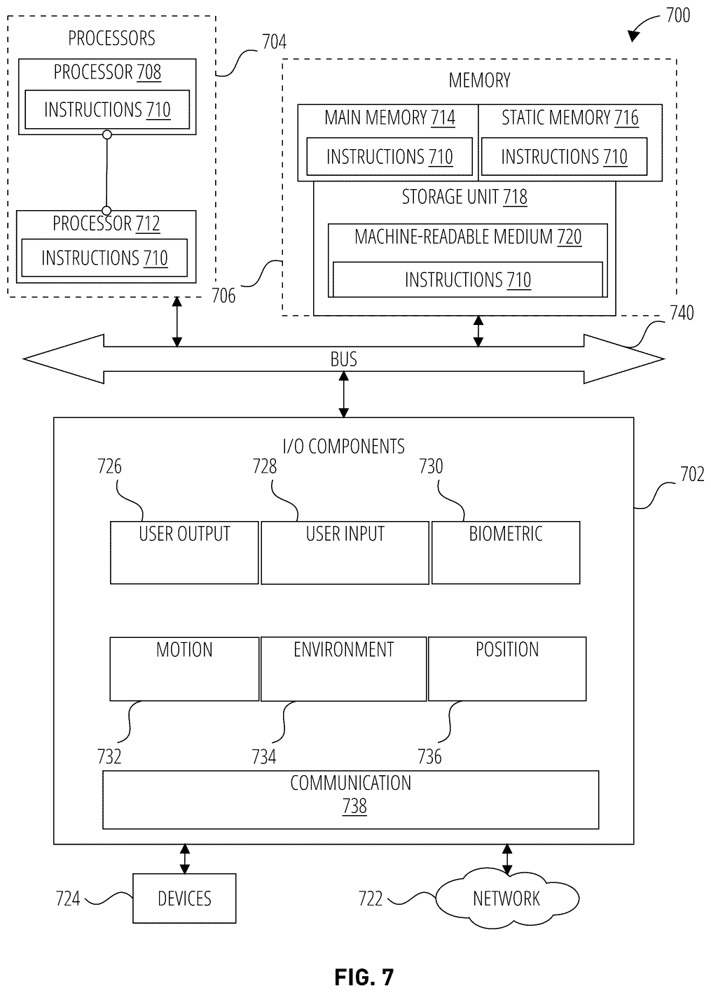

FIG. 7 is a diagrammatic representation of the machine 700 within which instructions 710 (e.g., software, a program, an application, an applet, an app, or other executable code) for causing the machine 700 to perform any one or more of the methodologies discussed herein may be executed. For example, the instructions 710 may cause the machine 700 to execute any one or more of the methods described herein. The instructions 710 transform the general, non-programmed machine 700 into a particular machine 700 programmed to carry out the described and illustrated functions in the manner described. The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 710, sequentially or otherwise, that specify actions to be taken by the machine 700. Further, while only a single machine 700 is illustrated, the term “machine” shall also be taken to include a collection of machines that individually or jointly execute the instructions 710 to perform any one or more of the methodologies discussed herein. The machine 700, for example, may comprise the client device 106 or any one of a number of server devices forming part of the messaging server system 104. In some examples, the machine 700 may also comprise both client and server systems, with certain operations of a particular method or algorithm being performed on the server-side and with certain operations of the particular method or algorithm being performed on the client-side.

The machine 700 may include processors 704, memory 706, and input/output I/O components 638, which may be configured to communicate with each other via a bus 740. In an example, the processors 704 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 708 and a processor 712 that execute the instructions 710. The term “processor” is intended to include multi-core processors that may comprise two or more independent processors (sometimes referred to as “cores”) that may execute instructions contemporaneously. Although FIG. 7 shows multiple processors 704, the machine 700 may include a single processor with a single-core, a single processor with multiple cores (e.g., a multi-core processor), multiple processors with a single core, multiple processors with multiples cores, or any combination thereof.

The memory 706 includes a main memory 714, a static memory 716, and a storage unit 718, both accessible to the processors 704 via the bus 740. The main memory 706, the static memory 716, and storage unit 718 store the instructions 710 embodying any one or more of the methodologies or functions described herein. The instructions 710 may also reside, completely or partially, within the main memory 714, within the static memory 716, within machine-readable medium 720 within the storage unit 718, within at least one of the processors 704 (e.g., within the Processor's cache memory), or any suitable combination thereof, during execution thereof by the machine 700.

The I/O components 702 may include a wide variety of components to receive input, provide output, produce output, transmit information, exchange information, capture measurements, and so on. The specific I/O components 702 that are included in a particular machine will depend on the type of machine. For example, portable machines such as mobile phones may include a touch input device or other such input mechanisms, while a headless server machine will likely not include such a touch input device. It will be appreciated that the I/O components 702 may include many other components that are not shown in FIG. 7. In various examples, the I/O components 702 may include user output components 726 and user input components 728. The user output components 726 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 702 may include biometric components 730, motion components 732, environmental components 734, or position components 736, among a wide array of other components. For example, the biometric components 730 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 732 include acceleration sensor components (e.g., accelerometer), gravitation sensor components, rotation sensor components (e.g., gyroscope).

The environmental components 734 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the client device 106 may have a camera system comprising, for example, front cameras on a front surface of the client device 106 and rear cameras on a rear surface of the client device 106. The front cameras may, for example, be used to capture still images and video of a user of the client device 106 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the client device 106 may also include a 360° camera for capturing 360° photographs and videos.

Further, the camera system of a client device 106 may include dual rear cameras (e.g., a primary camera as well as a depth-sensing camera), or even triple, quad or penta rear camera configurations on the front and rear sides of the client device 106. These multiple cameras systems may include a wide camera, an ultra-wide camera, a telephoto camera, a macro camera and a depth sensor, for example.

The position components 736 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 702 further include communication components 738 operable to couple the machine 700 to a network 722 or devices 724 via respective coupling or connections. For example, the communication components 738 may include a network interface Component or another suitable device to interface with the network 722. In further examples, the communication components 738 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 724 may be another machine or any of a wide variety of peripheral devices (e.g., a peripheral device coupled via a USB).

Moreover, the communication components 738 may detect identifiers or include components operable to detect identifiers. For example, the communication components 738 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 738, such as location via Internet Protocol (IP) geolocation, location via Wi-Fi® signal triangulation, location via detecting an NFC beacon signal that may indicate a particular location, and so forth.

The various memories (e.g., main memory 714, static memory 716, and memory of the processors 704) and storage unit 718 may store one or more sets of instructions and data structures (e.g., software) embodying or used by any one or more of the methodologies or functions described herein. These instructions (e.g., the instructions 710), when executed by processors 704, cause various operations to implement the disclosed examples.

The instructions 710 may be transmitted or received over the network 722, using a transmission medium, via a network interface device (e.g., a network interface component included in the communication components 738) and using any one of several well-known transfer protocols (e.g., hypertext transfer protocol (HTTP)). Similarly, the instructions 710 may be transmitted or received using a transmission medium via a coupling (e.g., a peer-to-peer coupling) to the devices 724.

### Software Architecture

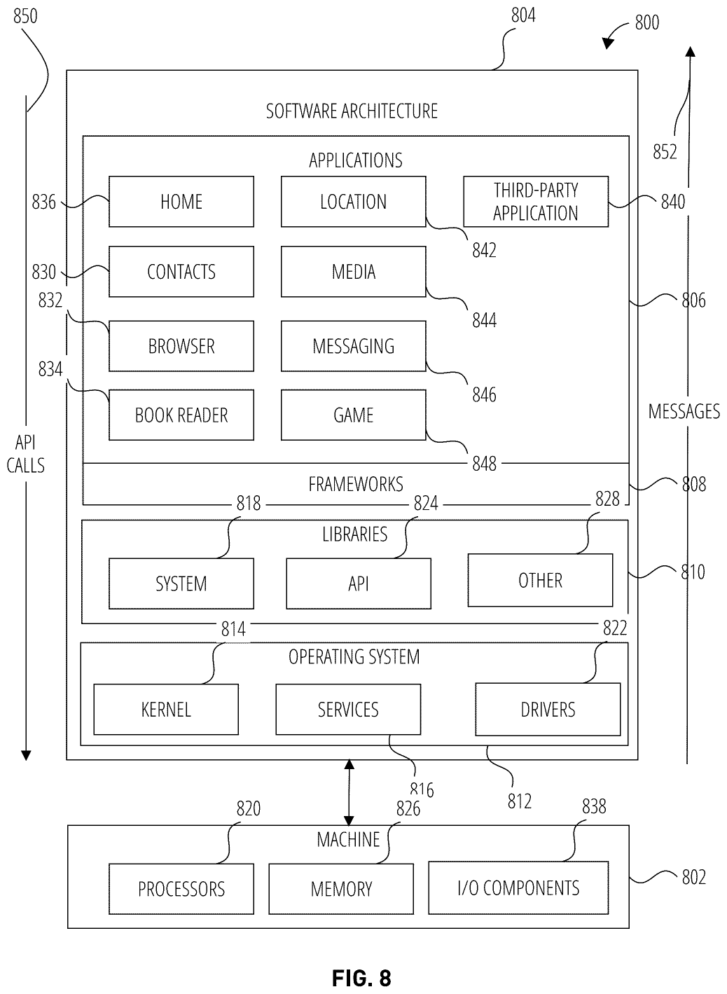

FIG. 8 is a block diagram 800 illustrating a software architecture 804, which can be installed on any one or more of the devices described herein. The software architecture 804 is supported by hardware such as a machine 802 that includes processors 820, memory 826, and I/O components 838. In this example, the software architecture 804 can be conceptualized as a stack of layers, where each layer provides a particular functionality. The software architecture 804 includes layers such as an operating system 812, libraries 810, frameworks 808, and applications 806. Operationally, the applications 806 invoke API calls 850 through the software stack and receive messages 852 in response to the API calls 850.

The operating system 812 manages hardware resources and provides common services. The operating system 812 includes, for example, a kernel 814, services 816, and drivers 822. The kernel 814 acts as an abstraction layer between the hardware and the other software layers. For example, the kernel 814 provides memory management, processor management (e.g., scheduling), component management, networking, and security settings, among other functionality. The services 816 can provide other common services for the other software layers. The drivers 822 are responsible for controlling or interfacing with the underlying hardware. For instance, the drivers 822 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 810 provide a common low-level infrastructure used by the applications 806. The libraries 810 can include system libraries 818 (e.g., C standard library) that provide functions such as memory allocation functions, string manipulation functions, mathematic functions, and the like. In addition, the libraries 810 can include API libraries 824 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 810 can also include a wide variety of other libraries 828 to provide many other APIs to the applications 806.

The frameworks 808 provide a common high-level infrastructure that is used by the applications 806. For example, the frameworks 808 provide various graphical user interface (GUI) functions, high-level resource management, and high-level location services. The frameworks 808 can provide a broad spectrum of other APIs that can be used by the applications 806, some of which may be specific to a particular operating system or platform.

In an example, the applications 806 may include a home application 836, a contacts application 830, a browser application 832, a book reader application 834, a location application 842, a media application 844, a messaging application 846, a game application 848, and a broad assortment of other applications such as a third-party application 840. The applications 806 are programs that execute functions defined in the programs. Various programming languages can be employed to create one or more of the applications 806, structured in a variety of manners, such as object-oriented programming languages (e.g., Objective-C, Java, or C++) or procedural programming languages (e.g., C or assembly language). In a specific example, the third-party application 840 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 840 can invoke the API calls 850 provided by the operating system 812 to facilitate functionality described herein.

### Processing Components

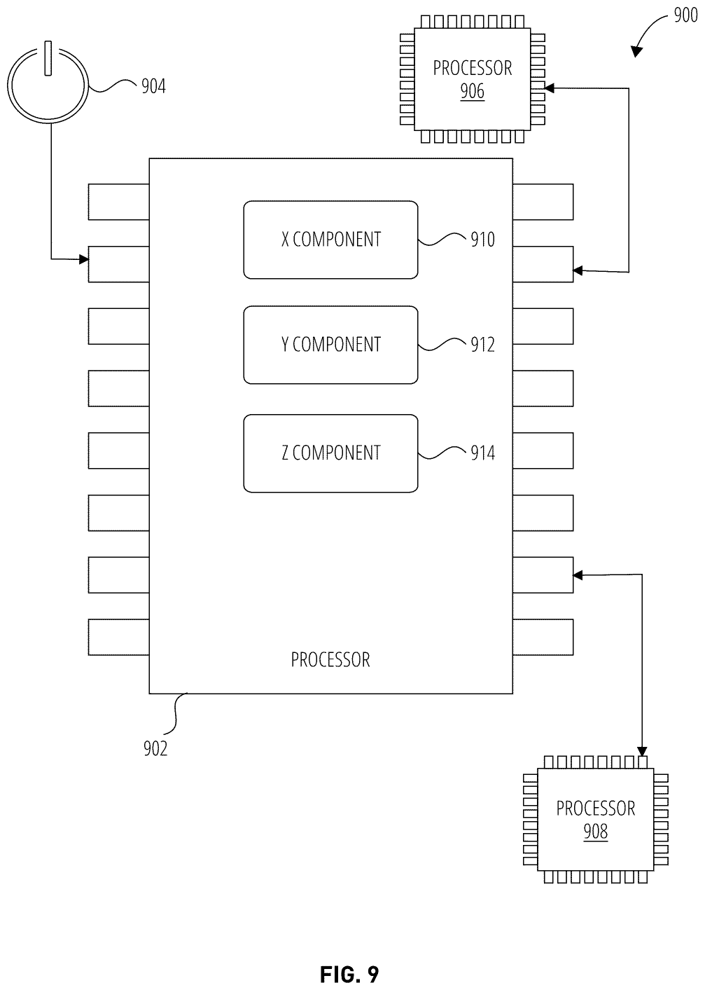

Turning now to FIG. 9, there is shown a diagrammatic representation of a processing environment 900, which includes a processor 902, a processor 906, and a processor 908 (e.g., a GPU, CPU or combination thereof).

The processor 902 is shown to be coupled to a power source 904, and to include (either permanently configured or temporarily instantiated) modules, namely an X component 910, a Y component 912, and a Z component 914, operationally configured to perform operations as discussed in the method 300 of FIG. 3, and the method 400 of FIG. 4, in accordance with embodiments discussed herein.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium”mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method comprising:
receiving initial pose data from a plurality of client devices, the plurality of client devices including at least a first client device and a second client device;
generating a posegraph based on the initial pose data;
detecting the first client device within a proximity of the second client device;
receiving relative pose observations from the first client device and the second client device responsive to the detecting the first client device within the proximity of the second client device; and
updating the posegraph based on the relative pose observations.

2. The method of claim 1, wherein the initial pose data comprises one or more of a list comprising:
visual-inertial odometry (VIO) data;
Simultaneous Localization And Mapping (SLAM) data;
Global Navigation Satellite System (GNSS) data
WiFi signal strength data;
image data; and
inertial measurement unit (IMU) data.

3. The method of claim 1, wherein the detecting the first client device within the proximity of the second client device includes:
detecting the first client device within a threshold distance of the second client device.

4. The method of claim 1, further comprising:
distributing the updated posegraph to the plurality of client devices.

5. The method of claim 1, further comprising:
localizing the plurality of client devices based on the updated posegraph.

6. The method of claim 1, wherein the detecting the first client device within the proximity of the second client device includes:
receiving first image data from the first client device, wherein the first image data comprises a first set of image features;
receiving second image data from the second client device, wherein the second image data comprises a second set of image features; and
detecting common image features among the first set of image features and the second set of image features.

7. The method of claim 1, wherein the detecting the relative pose between a first client device and a second client device includes:
receiving first image data from the first client device, wherein the first image data comprises a first set of image features;
receiving second image data from the second client device, wherein the second image data comprises a second set of image features; and
detecting common image features among the first set of image features and the second set of image features.

8. The method of claim 1, wherein the updating the posegraph based on the relative pose observations include:
assigning confidence values to the relative pose observations; and
updating the posegraph based on the confidence values and the relative pose observations.

9. The method of claim 7, wherein the assigning the confidence values to the relative pose observations is based on a data type of the relative pose observations.

10. The method of claim 2, wherein the image data is used to extract location of user hands;
location of user devices; and
location of user faces.
In the coordinate frame of the individual devices. These detections constitute relative poses in the posegraph.

11. The method of claim 9, wherein the updating the posegraph based on the relative pose observations include:
assigning confidence values to the relative pose observations; and
updating the posegraph based on the confidence values and the relative pose observations.

12. The method of claim 10, wherein the assigning the confidence values to the relative pose observations is based on a data type of the relative pose observations.

13. A system comprising:
one or more computer processors; and
one or more computer readable mediums storing instructions that, when executed by the one or more computer processors, causes the system to perform operations comprising:
receiving initial pose data from a plurality of client devices, the plurality of client devices including at least a first client device and a second client device;
generating a posegraph based on the initial pose data;
detecting the first client device within a proximity of the second client device;
receiving relative pose observations from the first client device and the second client device responsive to the detecting the first client device within the threshold distance of the second client device; and
updating the posegraph based on the relative pose observations.

14. The system of claim 13, wherein the initial pose data comprises one or more of a list comprising:
visual-inertial odometry (VIO) data;
Global Navigation Satellite System (GNSS) data
WiFi signal strength data;
image data; and
inertial measurement unit (IMU) data.

15. The system of claim 13, wherein the detecting the first client device within the proximity of the second client device includes:
detecting the first client device within a threshold distance of the second client device.

16. The system of claim 13, further comprising:
distributing the updated posegraph to the plurality of client devices.

17. The system of claim 13, further comprising:
localizing the plurality of client devices based on the updated posegraph.

18. The system of claim 13, wherein the detecting the first client device within the proximity of the second client device includes:
receiving first image data from the first client device, wherein the first image data comprises a first set of image features;
receiving second image data from the second client device, wherein the second image data comprises a second set of image features; and
detecting common image features among the first set of image features and the second set of image features.

19. The system of claim 13, wherein the updating the posegraph based on the relative pose observations include:
assigning confidence values to the relative pose observations; and
updating the posegraph based on the confidence values and the relative pose observations.

20. A non-transitory machine-readable storage medium comprising instructions that, when executed by one or more processors of one or more computing devices, cause the one or more computing devices to perform operations comprising:
receiving initial pose data from a plurality of client devices, the plurality of client devices including at least a first client device and a second client device;
generating a posegraph based on the initial pose data;
detecting the first client device within a proximity of the second client device;
receiving relative pose observations from the first client device and the second client device responsive to the detecting the first client device within the threshold distance of the second client device; and
updating the posegraph based on the relative pose observations.
